(19) United States
(12) Patent Application Publication
(10) Pub. No.: US 2005/0196510 A1
(43) Pub. Date: Sep. 8, 2005

(54) High protein beverage and method of producing same

(75) Inventor: Gale C. Walters, Vernon Hills, IL (US)

Correspondence Address: TETRA PAK US INTELLECTUAL PROPERTY DEPARTMENT;TETRA PAK INC., 101 COPORATE WOODS PARKWAY, VERNON HILLS, IL, 60061, US

(73) Assignee: Tetra Laval Holdings & Finance, S.A., Pully (CH)

(21) Appl. No.: 10/792,589

(22) Filed: Mar. 3, 2004

(51) Int. Cl. A23L 1/30

(52) U.S. Cl. 426/590

(57) ABSTRACT

A high-protein beverage is made with a protein content of at least 15% of the total product content. At least 10% of the total product consists of hydrolyzed gelatin. A method of producing a high-protein beverage product via UHT processing comprising at least 15% total protein also is disclosed.

### BACKGROUND OF THE INVENTION

The present invention is directed to a ready-to-drink, protein-enriched beverage product. More particularly, the present invention is directed to a meal replacement beverage with a total protein content of at least 15%.

As the diet and prepared food industries continue to expand, the demand for meal replacement beverages rises. Consumers on a diet or pressed for time favor meal replacement beverages as a quick, simple, portable, and healthy alternative to preparing food for themselves, or patronizing fast food restaurants. Because meal replacement beverage consumers tend to be health-conscious, manufacturers have attempted to follow popular dietary trends, creating low fat, vitamin-enriched, and lower-carbohydrate versions of their products.

Arguably, the most prevalent current dietary trend is a managed-carbohydrate diet (i.e. the ubiquitous Atkins diet). By strictly limiting their carbohydrates intake, adherents hope to shed fat rapidly. Low-carbohydrate diets tend to rely heavily on animal products, however, which require preparation time and are relatively difficult to transport. Meal replacement beverage manufacturers have tried to meet the needs of consumers following low-carbohydrate diets by increasing the protein content of their products, but have achieved only limited success.

One popular method for processing a beverage designed for non-refrigerated storage is Ultra High Temperature (“UHT”) pasteurization. Several different kinds of UHT systems are well known in the art. The UHT systems eliminate bacteria, thereby allowing treated beverages to be stored on a shelf at room temperature for an extended period of time. Manufacturers have been unable to produce a viable, UHT treated meal replacement beverage with protein content in excess of 10%, however, because the proteins most commonly used for enrichment, such as soy, egg, and dairy proteins, significantly thicken during the heating process.

Thickened proteins force a UHT system's pressure to drop. A beverage containing the thickened proteins therefore would need to be heated for a longer period of time for proper pasteurization. However, allowing a superheated product to remain in a UHT system for an extended period of time inevitably results in product burn-on, fouling and eventually shutting down the UHT system. Using soy, dairy, and egg proteins in UHT treated beverages is also problematic because they tend to develop sulfurous odors and flavors upon heating, taste unpleasantly dry, and gel during long-life, ambient storage. The maximum amount of protein manufacturers typically attempt to add is 9% of the total product, but even then the aroma and flavor faults still are present.

Accordingly, there exists a need for a ready-to-drink, high-protein meal replacement beverage utilizing an alternate protein source that does not thicken or suffer unfavorable changes in odor and flavor when heat-treated, or gel upon cooling and aging. Desirably, such a protein source is flavorless, odorless, and colorless when added to a beverage. Most desirably, such a beverage is formulated with a hydrolyzed gelatin content of at least 10% of the total product content. Even higher protein contents may be desirable for certain, specialized beverages. The beverage may include flavorings, minerals, vitamins, stabilizers, buffers, emulsifiers, and natural and/or artificial sweeteners.

### BRIEF SUMMARY OF THE INVENTION

A high-protein beverage is made with a protein content of at least 15% of the total product content. At least 10% of the total beverage product consists of hydrolyzed gelatin. In a preferred embodiment, the beverage product's entire protein content of at least 15% consists of hydrolyzed gelatin. Alternately, the hydrolyzed gelatin may be combined with dairy proteins to provide color and flavor characteristics familiar to consumers.

In the preferred embodiment, the beverage product also may include flavorings, minerals, vitamins, stabilizers, buffers, emulsifiers, and natural and/or artificial sweeteners.

A method of producing a high-protein beverage product also is disclosed. The method includes several steps: (1) providing proteins in an amount equal to at least 15% of the total beverage product with at least 10% of the total product consisting of hydrolyzed gelatin; (2) dispersing the proteins in water; (3) providing additional ingredients, such as flavorings, minerals, vitamins, stabilizers, buffers, emulsifiers, and natural and/or artificial sweeteners; (4) combining the proteins and the additional ingredients to create a mixture; (5) ultraheat treating the mixture; and (6) cooling the mixture. In a preferred embodiment, all of the proteins provided in step (1) consist of hydrolyzed gelatin. In an alternate embodiment, the proteins provided in step (1) consist of a blend of hydrolyzed gelatin and dairy proteins. Most preferably, the proteins and additional ingredients are mixed after adding each additional ingredient.

These and other features and advantages of the present invention will be apparent from the following detailed description, in conjunction with the appended claims.

### DETAILED DESCRIPTION OF THE INVENTION

While the present invention is susceptible of embodiment in various forms, there is shown in the drawings and will hereinafter be described a presently preferred embodiment with the understanding that the present disclosure is to be considered an exemplification of the invention and is not intended to limit the invention to the specific embodiment illustrated.

It should be further understood that the title of this section of this specification, namely, “Detailed Description Of The Invention”, relates to a requirement of the United States Patent Office, and does not imply, nor should be inferred to limit the subject matter disclosed herein.

The present invention is a ready-to-drink meal replacement beverage with a total protein content of at least 15%. A method of producing the beverage also is disclosed. Central to the invention's efficacy is the use of hydrolyzed gelatin as a protein source. Hydrolyzed gelatin is odorless, colorless, and tasteless. It is obtained through a partial hydrolysis of collagen present in animal tissues. Raw materials used for gelatin production include pigskins, cattle and fish skins, and pig, cattle, and poultry bones. Several companies offer hydrolyzed gelatin for sale. The gelatin used in the present invention is Vyse Gelatin Company's spray-dried gelatin hydrolysate, processed from beef hide collagen (Type B).

Though hydrolyzed gelatin provides the primary protein source for the present invention, other forms of protein may be included. For example, calcium caseinate may be added to further improve a beverage's flavor and color. However, additional sources of protein are not necessary to produce the subject meal replacement beverage.

The meal replacement beverage produced according to the present invention has multiple applications. Other ingredients may be added to further improve flavor, nutritive value, and stability, such as natural and artificial flavorings, natural and artificial sweeteners, minerals, vitamins, stabilizers, buffers, and emulsifiers. Examples of stabilizers may include microcrystalline cellulose and carrageenan. Buffers may include phosphates and citrates. Artificial sweeteners such as sucralose are especially valuable for promoting the subject meal replacement beverages to the high-protein, low-carbohydrate diet market. Consumers or retailers may freeze the meal replacement beverage for use as an ice cream substitute or ice cream mix. It also may be presented in a dried form, requiring consumers or manufacturers to rehydrate and mix the beverage to a ready-to-consume form. It should be understood that frozen and dried forms of the beverage are not aseptically packed, in contrast to the liquid form processed by UHT.

Not every type of ingredient listed above is necessary to successfully formulate a meal replacement beverage according to the present invention. Several different combinations of ingredients may lead to similar results. Two possible formulations are presented below, with percentages indicating the relative proportion of an ingredient present in the beverage.

### EXAMPLE 1

| | |
|---|---|
| Hydrolyzed gelatin | 16.50% |
| Sugar | 4.95% |
| Sucralose 25% solution | 0.028% |
| Flavorchem Vanilla WONF 2× | 0.349% |
| Vanilla Mocha Flavor | 0.056% |
| Tricalcium phosphate | 0.30% |
| Carrageenan | 0.01% |
| BK Guilini JOHA KM2 blend of | 0.25% |
| phosphates and citrate | |
| High-oleic vegetable oil | 1.00% |
| Water | 76.557% |
| Total | 100% |

### EXAMPLE 2

| | |
|---|---|
| Hydrolyzed gelatin | 10.00% |
| Calcium caseinate | 6.67% |
| Sugar | 4.95% |
| Sucralose 25% solution | 0.028% |
| Flavorchem Vanilla WONF 2× | 0.349% |
| Vanilla Mocha Blend Flavor | 0.056% |
| Tricalcium phosphate | 0.24% |
| BK Guilini JOHA KM2 blend of | 0.50% |
| phosphates and citrate | |
| High-oleic sunflower oil | 0.90% |
| Water | 76.307% |
| Total | 100% |

Regardless of the specific ingredients and proportions used in any given formulation, all meal replacement beverages made according to the present invention are produced via the same method. First, the protein components (i.e. the gelatin and, if used, the calcium caseinate or other additional protein) are added to water. The proteins are allowed to disperse in the water for approximately thirty (30) minutes.

Next, any buffers (such as the tricalcium phosphate and BK Guilini JOHA KM2 blend of phosphates and citrates of Examples 1 and 2) are added to the water and protein(s). Immediately afterwards, any stabilizers (such as the carrageenan of Example 1) are added to the water, protein(s), and buffers. If stabilizers are used, they are pre-blended with a portion (typically around 1%) of the sugar. The stabilizers, sugar, buffers, protein(s), and water are allowed to mix for approximately twenty (20) minutes.

Then, the rest of the sugar is added, along with any oils, flavors, and the sucralose (or other artificial sweeteners). The completed formula is allowed to mix once more, for approximately twenty (20) minutes, and then treated by a UHT system. Although a tubular indirect UHT system was used to process the beverage of the present invention, other types of UHT systems, such as a direct steam UHT system, may be used as well. After processing, the beverage is cooled and packaged.

All patents referred to herein, are hereby incorporated herein by reference, whether or not specifically done so within the text of this disclosure.

In the present disclosure, the words “a” or “an” are to be taken to include both the singular and the plural. Conversely, any reference to plural items shall, where appropriate, include the singular.

From the foregoing it will be observed that numerous modifications and variations can be effectuated without departing from the true spirit and scope of the novel concepts of the present invention. It is to be understood that no limitation with respect to the specific embodiments illustrated is intended or should be inferred. The disclosure is intended to cover by the appended claims all such modifications as fall within the scope of the claims.

1. A high-protein beverage product comprising at least 15% protein, wherein at least 10% of the total product consists of hydrolyzed gelatin.

2. The beverage product of claim 1, wherein the at least 15% protein consists of a blend of the hydrolyzed gelatin and dairy proteins.

3. The beverage product of claim 1, wherein the entire total protein content of at least 15% consists of hydrolyzed gelatin.

4. The beverage product of claim 1, further comprising an ingredient selected from the group consisting of natural and artificial flavorings, minerals, vitamins, stabilizers, buffers, emulsifiers, and natural and artificial sweeteners.

5. The beverage product of claim 1, wherein the product is in a frozen form.

6. The beverage product of claim 1, wherein the product is in a dry powder form.

7. A process for producing a high-protein beverage product comprising the following steps:
(a) providing proteins in an amount equal to at least 15% of the total product, wherein at least 10% of the total product consists of hydrolyzed gelatin;
(b) dispersing the proteins in water;
(c) providing additional ingredients selected from the group consisting of flavorings, minerals, vitamins, stabilizers, buffers, emulsifiers, and natural and artificial sweeteners;
(d) combining the proteins and the additional ingredients to create a mixture;
(e) ultraheat treating the mixture; and
(f) cooling the mixture.

8. The process of claim 7, wherein the proteins provided in step (a) consist of a blend of the hydrolyzed gelatin and dairy proteins.

9. The process of claim 7, wherein the proteins provided in step (a) entirely consist of hydrolyzed gelatin.

10. The process of claim 7, including the step of mixing the proteins and additional ingredients after adding each additional ingredient.
